(19) United States
(12) Patent Application Publication
(10) Pub. No.: US 2019/0293249 A1
(43) Pub. Date: Sep. 26, 2019

(54) METHOD AND APPARATUS FOR DYNAMICALLY PROJECTING AND DISPLAYING CUSTOMIZED DECORATIVE IMAGES ON A BUILDING OR HOME

(71) Applicant: Allister B. Hamilton, Albuquerque, NM (US)

(72) Inventor: Allister B. Hamilton, Albuquerque, NM (US)

(21) Appl. No.: 15/927,146

(22) Filed: Mar. 21, 2018

(51) Int. Cl. F21S 10/00; F21V 17/02; F21V 21/08; G06F 3/0482; G06F 3/0484

(52) U.S. Cl. CPC F21S 10/007; F21V 17/02; F21W 2131/107; G06F 3/0482; G06F 3/04845; F21V 21/0824

(57) ABSTRACT

Methods and systems for displaying customized decorative lighting onto a structure. An image of an area of a structure such as a house building can be captured with an image-capturing device. The image of the area of the building is graphically modified to include decorative features added to the building image via image processing. A slide can be generated, which includes the modified image of the building with the added customized decorative features. The slide is receivable by a slot configured in a decorative lighting apparatus, which includes or functions as a projector for projecting the modified image with the decorative images onto the actual building.

### TECHNICAL FIELD

Embodiments are generally related to the field of decorative lighting for structures such as homes and buildings. Embodiments additionally relate to projectors that project and display images onto structures such as homes or buildings.

Embodiments further relate to a downloadable self-contained software application for use on a mobile device and/or with the web on a desktop application.

### BACKGROUND

Lighting is often used in a decorative manner. For example, many people decorate homes, offices, stores, outdoor spaces, and other structures, etc., with various lighting to achieve certain effects, designs, atmospheres, festive moods, etc. Although decorative lighting may be used at any time of the year, many people utilize decorative lighting during certain holidays.

There are many types of decorative lighting. For example, string lights, character lights, and laser lights are just a few of the various forms of decorative lighting. However, existing laser lights having numerous shortcomings in their design and functionality. For example, many conventional decorative lighting devices project and display lighting in a random and haphazard function and do not allow users to customize or configure a particular arrangement of lighting for projection and display on their homes.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved methods, systems, and devices for projecting decorative features such as decorative lighting onto structures such as homes and buildings.

It is another aspect of the disclosed embodiments to provide for a decorative lighting apparatus that includes a projector for projecting a modified image of a structure onto the structure.

It is a further aspect of the disclosed embodiments to provide for a decorative lighting apparatus configured with a slot for receiving a slide containing a customized image of a structure, wherein the decorative lighting apparatus includes a projector for projecting a modified image of the structure onto the structure from the slide.

It is an additional aspect of the disclosed embodiments to provide for a software application usable on a mobile device for customizing an image of a structure and transmitting the image to a third party vendor or service for manufacturing of a slide containing the customized image of the structure.

The aforementioned aspects and other objectives and advantages can now be achieved as described herein. Methods and systems for displaying customized decorative lighting onto a structure are described herein. An image of an area of a structure such as a house building can be captured with an image-capturing device. The image of the area of the building is graphically modified to include decorative features added to the building image via image processing. A slide can be generated, which includes the modified image of the building with the added customized decorative features. The slide is receivable by a slot configured in a decorative lighting apparatus, which includes or functions as a projector for projecting the modified image with the decorative images onto the actual building.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a system for displaying customized decorative lighting on a house or building, in accordance with an example embodiment;

FIG. 2 illustrates a flow chart of operations depicting a method for capturing, modifying, and displaying customized decorative lighting on a house or building, in accordance with an example embodiment;

FIG. 3 illustrates a flow chart of operations depicting a method for capturing, modifying, and displaying customized decorative lighting on a house or building, in accordance with another example embodiment;

FIG. 4 illustrates a schematic diagram comparing a conventional decorative lighting projection system with the disclosed customized light projector embodiment;

FIG. 5 illustrates a pictorial diagram of a decorative lighting apparatus that includes a projector for projecting an image of decorative images onto an area of a house or building, in accordance with an example embodiment;

FIG. 6 illustrates a block diagram depicting an example mobile device that can be adapted for use with one or more embodiments;

FIG. 7 illustrates a schematic view of a computer system/apparatus, which can be adapted for use in accordance with an example embodiment;

FIG. 8 illustrates a schematic view of a software system including a module, an operating system, and a user interface, which can also be adapted for use in accordance with an example embodiment;

FIGS. 9-10 illustrate a pictorial flow diagram depicting operational steps of a process for implementing and operating a light customization app that dynamically projects and displays customized decorative images on a building or home, in accordance with an example embodiment; and

FIGS. 11-12 illustrate a pictorial diagrams depicting additional operations of app features for dynamically projecting and displaying customized decorative images on a building or home, in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

Aspects of the disclosed embodiments can be implemented in numerous ways, including as a process or method; a system or apparatus; a computer program product embodied on a computer readable storage medium; and/or a processor, such as a processor configured to execute instructions stored on and/or provided by a memory coupled to the processor. In general, the order of the steps of disclosed processes/methods (e.g., steps, operations, or instructions) may be altered within the scope of the technology. Unless stated otherwise, a component such as a processor or a memory described as being configured to perform a task may be implemented as a general component that is temporarily configured to perform the task at a given time or a specific component that is manufactured to perform the task. As used herein, the term ‘processor’ can refer to one or more devices, circuits, and/or processing cores configured to process data, such as computer program instructions. The term processor as utilized herein devices such as, for example, a microprocessor, a CPU (Central Processing Unit), a GPU (Graphical Processing Unit), microcontroller, and so on.

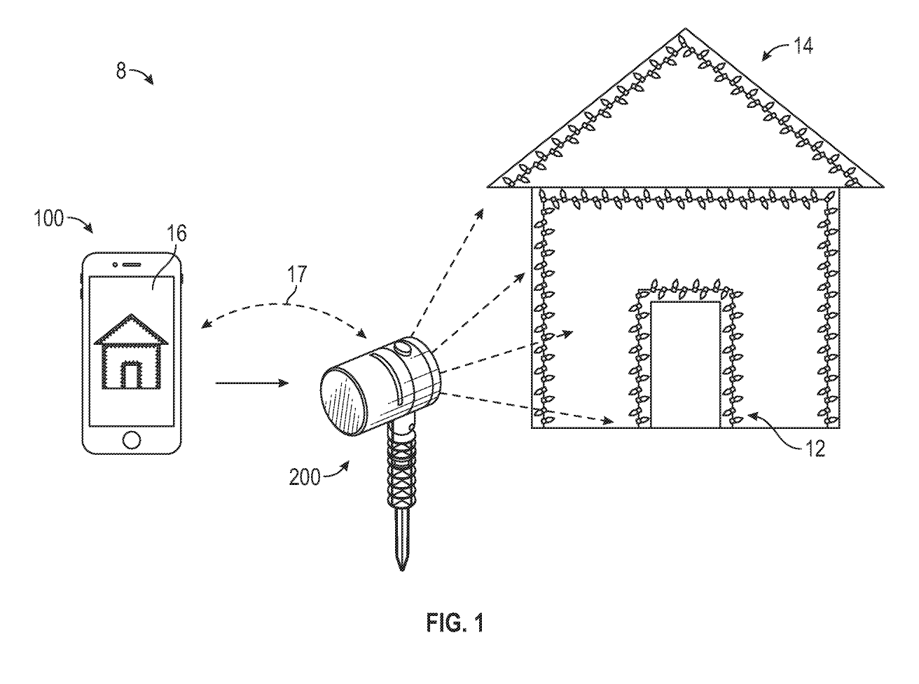

FIG. 1 illustrates a schematic diagram of a system 8 for displaying customized decorative lighting on a structure 14 such as a house or building, in accordance with an example embodiment. As shown in FIG. 1, a decorative lighting apparatus 200 (i.e., a projector) projects customized decorative features 12 onto the structure 14. A user can use his or her client device 100 (e.g., a laptop, a smartphone, or a tablet) to capture a digital image (i.e., take a photo) of the structure 14 and then use an “app” (i.e., a downloadable self-contained software application) to modify the digital image of the structure to add the customized decorative features 12 to the image of the structure 14. Note that in some instances, the “app” may be implemented not only as a mobile application for a mobile device, but also as an application accessible through a website on another type of computing device such as a desktop computer.

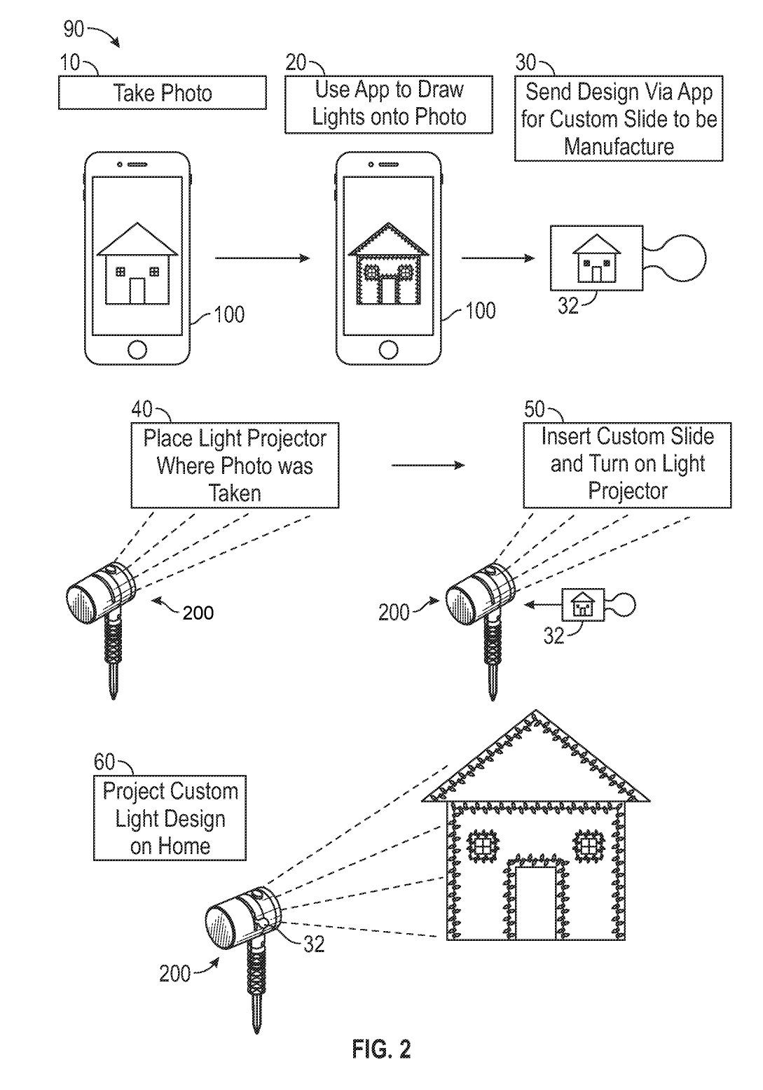

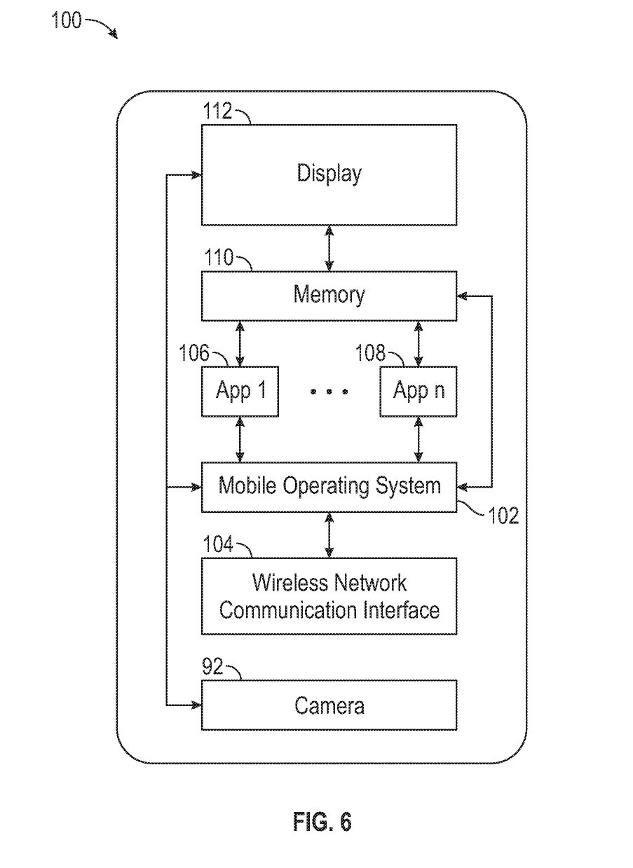

In any event, the resulting modified image 16 can be displayed in a display screen or display of the client device 100 and can be transferred to a company or vendor via the aforementioned app (an example of a display is the display 112 shown in FIG. 6). The company/vendor or third party service creates a slide (e.g., see slide 32 in FIG. 2) that can be inserted into the decorative lighting apparatus 200 for projection of the modified image (e.g., the structure 14 graphically modified to display holiday lights along profile lines or particular areas of the image of the structure 14) onto the actual structure 14. The company or third party service or agent can mail the customized slide to the user who then inserts the slide into and out of the decorative lighting apparatus 200 as needed. The system 8 allows, for example, for customized lights to be projected onto the structure 14.

The user initially takes a photo of the structure with the aforementioned app running on the client device 100. An image-capturing device such as a camera associated with a mobile device captures the image or photo. The location where the image was captured can be identified and recorded by the app via, for example, geolocation techniques such as GPS (Global Positioning Satellite), triangulation, and so on. The exact location where the photo or image was taken is important because eventually the decorative lighting apparatus with a slide containing a modified/customized image is preferably located back at the original location where the image was captured so that the new image contained on the slide can be projected onto the actual structure or building shown in the modified image. Note that the term geolocation as utilized herein refers to the process or technique of identifying the geographical location of a person or device by means of digital information processed via, for example, the Internet or other processing or communications means. The app can thus be configured with geolocation features.

The app is configured to allow the user to draw in the image of the structure the lights or features that the user desires to be projected onto his or her home, for example, using the decorative lighting apparatus 200. The user transmits his or her design (i.e., the modified image of the structure) to the third party service or company via the app. The company or third party service manufactures and then sends the slide with the modified image by mail back to the user for the user to put into the decorative lighting apparatus 200 (i.e., a projector) for projection of the customized images onto structure 14.

Note that in some example embodiments, the projector 200 may be configured to communicate wirelessly and directly with the client device 100 (e.g., a mobile device). The projector 200 may also be configured to receive data wirelessly from the client device 100, wherein such data is indicative of the image of structure 14 with the light projection display, and this image is then processed by the projector for display on the structure 14 as discussed herein. Such an implementation can avoid the necessity of manufacturing a separate slide for eventual projection.

FIG. 2 illustrates a flow chart of operations depicting a method 90 for capturing, modifying, and displaying customized decorative lighting on a house or building, in accordance with an example embodiment. As indicated at step 10, a user initially takes a photo of the structure 14 using his or her client device 100. Next, as shown at step 20, the user can use the aforementioned app to draw lights (i.e., decorative features) onto the captured image.

Thereafter, as shown at step 30, the modified image or design can be transmitted to a third party service or vendor via the mobile phone “app” for manufacturing of a customized slide 32 with the modified/customized image of the house (e.g., with added lights or other decorative features). Next, as shown at step 40, the decorative lighting apparatus 200 or light projector can be located/placed back at the location where the original photo of structure 14 was taken. Then, as indicated at step 50, the user inserts the slide 32 into the decorative lighting apparatus 200 and turns on the apparatus or projector 200. Note that the decorative lighting apparatus 200 can be configured with a zoom feature, which allows the projected image (i.e., from the slide) to be expanded or reduced when projected onto, for example, a wall of the structure 14. Finally, as shown at block 60, the customized light features contained on the slide 32 are projected by the decorative lighting apparatus 200 onto the actual structure 14.

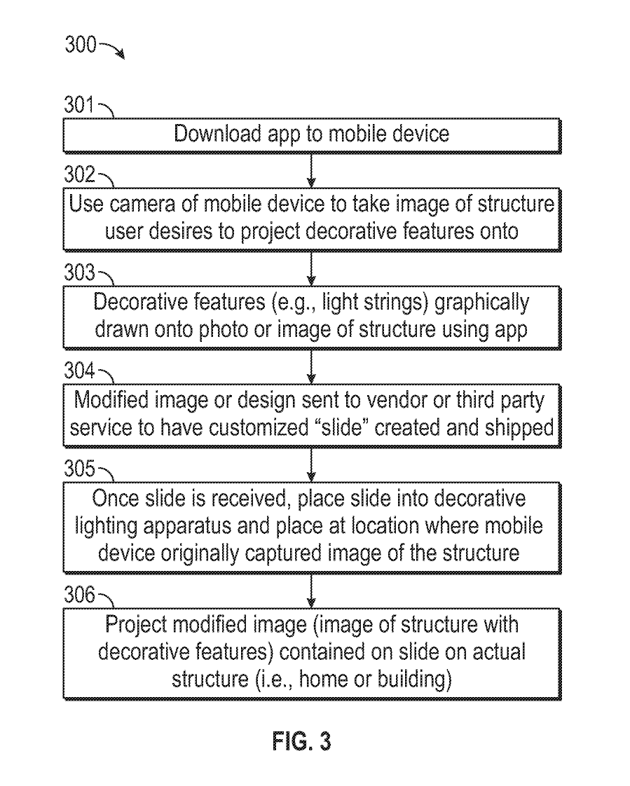

FIG. 3 illustrates a flow chart of operations depicting a method 300 for capturing, modifying, and displaying customized decorative lighting on a structure such as a house or building, in accordance with another example embodiment. As shown at block 301, a step or operation can be implemented in which the aforementioned app is downloaded to a mobile device such as the client device 100 discussed herein. The client device 100 includes an image-capturing device such as a camera. This image-capturing device is used to take an image/photo of the structure that the user desires to project decorative features onto, as indicated at block 302. The disclosed app will walk the user through the process of placing the mobile device in a particular location with respect to the structure to allow for the capturing of a proper image for subsequent modification/design and projection. Note that a stand such as a cell phone stand may be used for placing the mobile device into the proper location for capturing the image of the structure.

Next, as shown at block 303, a step or operation can be implemented in which the user graphically draws onto the image/photo of the structure, decorative features (e.g., light strings). In this particular operation, the app can offer the user different types of designs and colors of decorative features, and the user can select a particular type of design and/or colors for his or her design. The process of drawing on the image or modifying the image can occur through the use of image processing techniques. Note that the term “image processing” as utilized herein refers generally to digital image processing, which involves the use of computer algorithms to perform image processing on digital images.

In addition, the app in some embodiments may utilize a filter or filter module that allows a user to select particular features and finter or modify the image using such filters. One non-limiting example of a filtering technique that can be adapted for use in accordance with an example embodiment is disclosed in U.S. Patent Application Publication No. 2016/0006927, entitled “Apparatus and Method for Supplying Content Aware Photo Filters,” which published on Jan. 7, 2016 and is incorporated herein by reference in its entirety. In this example, a server can be configured with a photo filter module with instructions executed by a processor to identify when a client device captures a photograph. Photograph filters are selected based upon attributes of the client device and attributes of the photograph. The photograph filters are then supplied to the client device. Another non-limiting example of a filtering technique that can be adapted in accordance with an example embodiment is disclosed in U.S. Pat. No. 9,459,778, entitled “Methods and Systems of Providing Visual Content Editing Functions,” which issued on Oct. 4, 2016 and is incorporated herein by reference in its entirety.

Next, as shown at block 304, the modified or customized image of the structure can be sent to a vendor or third party service that generates a slide with the customized image and ships slide to the user. Once the slide is received by the user, as shown at block 305, the user can place the slide into the decorative lighting apparatus and locate the decorative lighting apparatus at the location where the mobile device originally captured the image of the structure. Thereafter, as shown at block 306, the modified image contained on the slide can be projected by the decorative lighting apparatus onto the actual structure (e.g., home or other building).

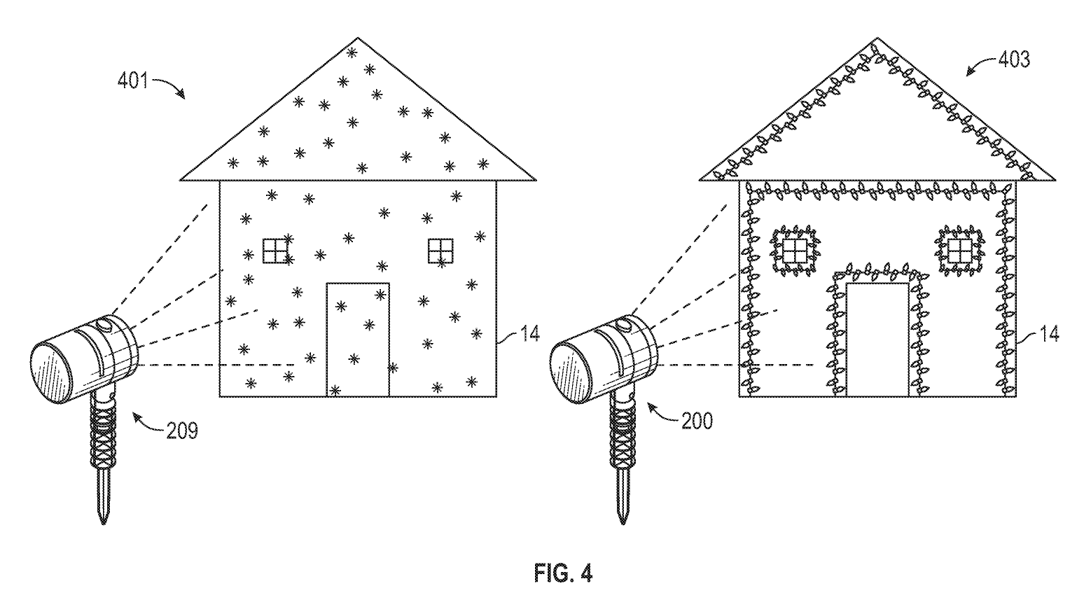

FIG. 4 illustrates a schematic diagram comparing a conventional decorative lighting projection system 401 to the disclosed customized light projector system 403. In the conventional system 401, a projector 209 offers only haphazard generic lighting for display on a home or building. The decorative features in such conventional systems are displayed randomly over an area on the structure 401. In contrast to such a random or haphazard projection, the improved system 403 allows the lights to be custom projected onto a user's structure 403 (e.g., the user's home or building).

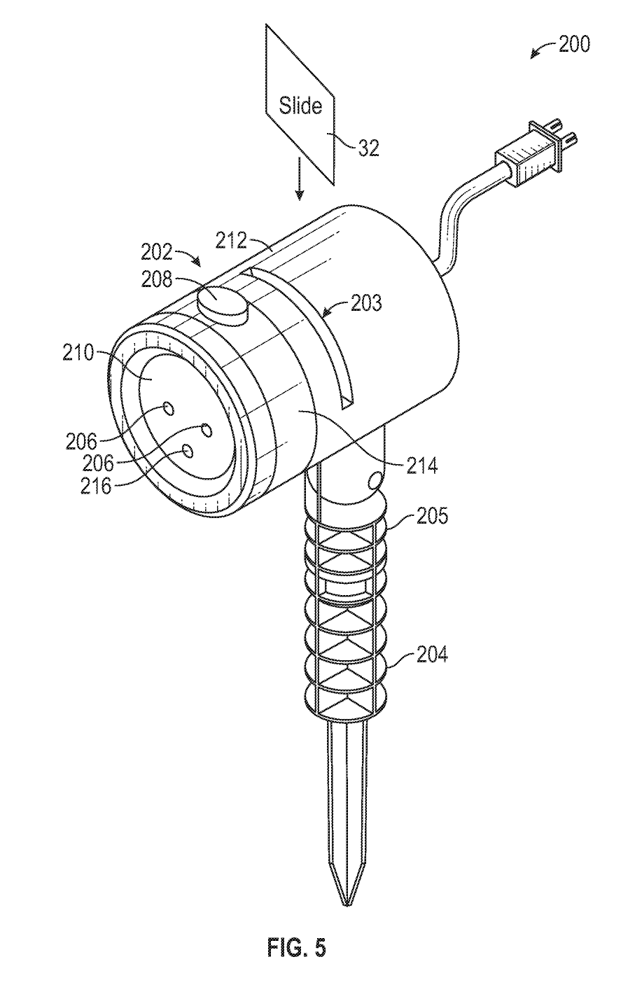

FIG. 5 illustrates a perspective view of an example decorative lighting apparatus 200 that includes a projector for projecting an image of decorative images onto an area of a house or building, which may be implemented in accordance with an example embodiment. The example decorative lighting apparatus 200 shown in FIG. 5 can include a body 202, a mounting element 204, one or more light sources 206, a switch 208, and a light sensor 216. The body 202 can be configured with a slot 203 capable of receiving the slide 32 having the previously discussed customized image.

According to one example embodiment, in operation, decorative lighting apparatus 200 can be positioned via the mounting element 204 and coupled to a power source. A user can then actuate switch 208 to control the operation of the decorative lighting apparatus 200. When the decorative lighting apparatus 200 is tumed on via the switch 208, the light sources 206 are activated to produce light, and the decorative lighting apparatus 200 thereby emits and projects the light generated by light sources 206 onto a target, such as the wall of the structure 14. According to certain example embodiments, the light generated by the light sources 206 passes through a light attenuator to attenuate the light being emitted and projected by decorative lighting apparatus 200 and project the image contained on the slide 32 situated in the slot 203.

In some example embodiments, the decorative lighting apparatus 200 can generate any combination of colored light depending on the light source(s) 206 employed by decorative lighting apparatus 200. For example, light source(s) 206 may include one or more light sources all producing the same color light (e.g., green) so that decorative lighting apparatus 200 only emits and projects one color light. Alternatively, light source(s) 206 may include multiple light sources capable of producing lights of various colors so that decorative lighting apparatus 200 can generate multiple different colored lights (e.g., red light and green light). Although the example embodiments are primarily described with respect to a decorative laser lighting apparatus generating two or more different colored lights (i.e., red light and green light), it is not limited thereto, and it should be noted that the exemplary apparatus and systems described herein may generate any combination of any number of different colored lights.

As shown in FIG. 5, the body 202 may be cylindrical in shape and preferably houses the mechanical and electrical components of decorative lighting apparatus 200. For example, body 202 may include housing 212, light source(s) 206, light cover 210, switch 208, switch visual indicator 214, and light sensor 216. Inside housing 212, body 202 may house electronic circuitry (not shown) that enables the electrical operation of decorative lighting apparatus 100, as well as various mechanical components (not shown) that facilitate the design and operation of decorative lighting apparatus 100. Note that in some example embodiments, the decorative lighting apparatus 200 may also include a motion switch to control a motion, modulation, or articulation of light source(s) 206. The body 202 can be coupled to a pivoting arm 205 via a coupling element.

It should be appreciated that the decorative lighting apparatus 200 shown in FIG. 5 is but one example of a decorative lighting apparatus 200 that can be adapted for use in accordance with one or more example embodiments. The particular features of decorative lighting apparatus 200 are not considered limiting features of the disclosed embodiments. That is, other types of decorative lighting devices may be utilized in place of the example decorative lighting apparatus 200 shown in FIG. 5. One non-limiting example of a decorative lighting apparatus, which can be adapted for use in some example embodiments as the decorative lighting apparatus 200, is disclosed in U.S. Pat. No. 9,546,775, entitled “Decorative Lighting Apparatus Having Two Laser Light Sources,” which issued on Jan. 17, 2017 and is incorporated herein by reference in its entirety.

It can be further appreciated that the decorative lighting apparatus 200 (e.g., a projector) can be configured as a device that does not use an actual physical slide such as slide 32, but which communicates wirelessly (e.g., Bluetooth communications, etc.) with the client device 100. In this scenario, the client device 100 can be used with an “app” as discussed herein to take a photo of a structure, and create the disclosed customized slide display and the resulting modified image of the structure, which is then transmitted as a digital slide directly to the decorative lighting apparatus 200, which then projects the resulting image as discussed herein.

FIG. 6 illustrates a block diagram depicting an example client device 100 that can be adapted for use with one or more embodiments. In the example shown in FIG. 6, the client device 100 (e.g., a mobile phone, tablet, or other mobile device) can include a mobile operating system 102 running on a processor (not shown). Mobile network connectivity can be provided via a wireless network communication interface 104, which is configured to transmit and receive information via a wireless radiotelephone subsystem that includes an antenna, transceiver, and associated components to provide wireless communication connectivity via a mobile network to other mobile devices and to networked computers, such as computer servers, via the Internet and/or other networks.

A set of mobile applications (sometimes “mobile app” or “app”), represented in FIG. 6 by mobile apps 106 and 108, are stored on the client device 100 on a storage drive or other persistent storage device (not shown) and each is configured to run on top of mobile operating system 102, including by invoking services of mobile operating system 102 to communicate via wireless network communication interface 104 with remote resources, such as application servers running applications and/or services with which the mobile app is associated.

Mobile operating system 102 and mobile apps represented by apps 106 and 108 have access to and use a memory 110 to store and retrieve data. For example, mobile operating system 102 may allocate to each app a region of memory to be used by that app to store app-related data. Similarly, each app may be allocated a set of logical locations in a persistent storage managed by mobile operating system 102, e.g., an app-specific directory in a file system used by mobile operating system 102 to manage persistently stored objects. Mobile operating system 102 is connected to and manages app interactions with a display subsystem 112. Display subsystem 112 (sometimes “display”) includes a touch-sensitive display device, for example, a capacitive or other display able to generate and provide to mobile operation system 102 signals representative of single and/or multi-touch gestures, such as swiping (and the direction thereof), pinching in or out, dragging, and dropping. A mobile app such as app 106 or app 108 may be configured to display app display pages, e.g., app user interface pages, content display pages, etc., via display 112. A mobile app also may be configured to receive user input provided via display 112, e.g., selection, dragging, dropping, and/or other user input associated with physical interactions with the touch-sensitive surface of display 112.

A mobile app, such as the app 106 or app 108 of FIG. 6, typically provides access to app functionality via a mobile app user interface displayed via a display device of the mobile device. Information and/or user interactive controls may be displayed. Users may access further functionality and/or control the manner in which functionality is provided and/or the content displayed by performing touches and/or gestures (e.g., select an object, activate a button or other control, drag an object to a new location, drag an object to a location associated with a control input-such as dragging a file icon to a folder to add the file to the folder, etc.) Typically, mobile users navigate through successive pages of a mobile app's interface. However, typically to reach a previously viewed mobile app page it may be necessary to navigate back to that page, which requires the mobile app to regenerate the desired page and any intervening pages through which the user must navigate to get back to the desired page. Typically, a mobile app only has a single currently active page, i.e., the one currently being displayed.

It should be appreciated that the client device 100 shown in FIG. 6 is one example of a mobile device that can be implemented in accordance with the disclosed embodiments. Other types of mobile devices, however, can be implemented as client device 100. For example, U.S. Pat. No. 9,860,354 entitled “Electronic Device With Camera-Based User Detection,” which issued on Jan. 2, 2018 and is incorporated herein by reference in its entirety, discloses an example of a mobile device that can be adapted for use as client device 100.

The client device 100 is configured to communicate wirelessly via bidirectional packet based wireless communications with a variety of different types of wireless networks. For example, the client device 100 can communicate wirelessly with a wireless network (or networks) that employs stand-alone ad-hoc networks, mesh networks, wireless LAN (WLAN) networks, cellular networks, or the like. Such a wireless network can include a system of terminals, gateways, routers, or the like coupled by wireless radio links, or the like, which may move freely, randomly, or organize themselves arbitrarily, such that network topology may change, at times even rapidly. Such a wireless network may also employ a plurality of network access technologies including Long Term Evolution (LTE), WLAN, Wireless Router (WR) mesh, or 2nd, 3rd, 4^{th}, 5^{th} generation (2G, 3G, 4G, 5G, etc.) cellular technology, or the like. Network access technologies may enable wide area coverage for devices, such as client devices with varying degrees of mobility, for example.

Such a wireless network may also enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. Such a wireless network may include virtually any type of wireless communication mechanism by which signals may be communicated between devices, such as a client device or a computing device, between or within a network, or the like.

As can be appreciated by one skilled in the art, embodiments or aspects of such embodiments can be implemented in the context of a method, data processing system, or computer program product. Accordingly, some example embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object-oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN), a wide area network (WAN), wireless data network e.g., Wi-Fi, Wimax, 802.xx, a wireless local area network (WLAN), and cellular networks, or the connection may be made to an external computer via most third party supported networks (for example, through the Internet utilizing an Intenet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, however, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer. In some example embodiments, the data processing system apparatus discussed herein can be implemented as a special-purpose computer. A printing system thus may be a special-purpose computer in some cases.

The computer program instructions discussed herein may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein. Such instructions can, for example, include instructions (i.e., steps or operations) such as described herein with respect to FIGS. 2-3 and elsewhere.

Note that a processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general-purpose processor, a digital signal processor (DSP), an integrated circuit, a server, other programmable logic device, or any combination thereof. A processor may be a conventional processor, microprocessor, controller, microcontroller, or state machine. A processor can also refer to a chip or part of a chip (e.g., semiconductor chip). The term “processor” may refer to one, two, or more processors of the same or different types. It is noted that a computer, computing device and user device, and the like, may refer to devices that include a processor, or may be equivalent to the processor itself.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/facts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

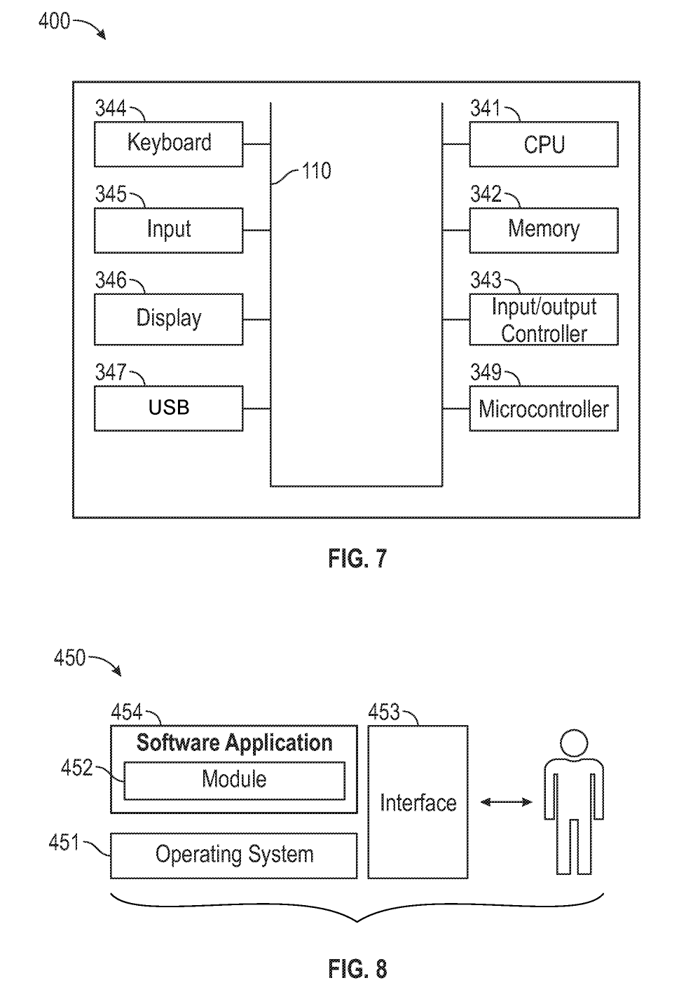

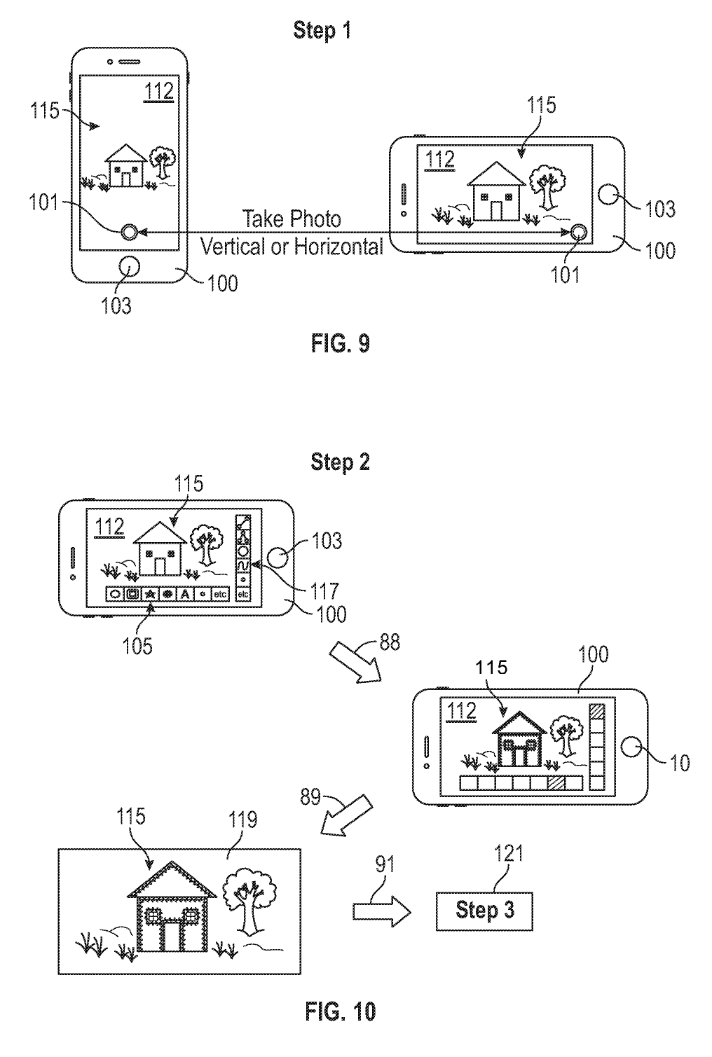

FIGS. 7-8 are shown only as exemplary diagrams of data-processing environments in which example embodiments may be implemented. It should be appreciated that FIGS. 7-8 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 7, some embodiments may be implemented in the context of a data-processing system/apparatus 400 that can include, for example, one or more processors such as a processor 341 (e.g., a CPU (Central Processing Unit) and/or other microprocessors), a memory 342, an input/output controller 343, a microcontroller 349 (which may be optional), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.), and/or other peripheral connections and components.

As illustrated, the various components of data-processing system/apparatus 400 can communicate electronically through a system bus 351 or similar architecture. The system bus 351 may be, for example, a subsystem that transfers data between, for example, computer components within data-processing system/apparatus 400 or to and from other data-processing devices, components, computers, etc. The data-processing system/apparatus 400 may be implemented in some embodiments as, for example, a server in a client-server based network (e.g., the Internet) or in the context of a client and a server (i.e., where aspects are practiced on the client and the server).

In some example embodiments, data-processing system/apparatus 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc.). In still other example embodiments, the data-processing system/apparatus 400 may communicate wirelessly with other devices or systems through a bidirectional packet-based wireless communications network (e.g., cellular networks, Wi-Fi, etc.).

FIG. 8 illustrates a computer software system/apparatus 450 for directing the operation of the data-processing system/apparatus 400 depicted in FIG. 7. The computer software system/apparatus 450 includes a software application 454, an OS (Operating System) 451, and a shell or interface 453. The software application 454 can be stored in, for example, memory 342 shown in FIG. 7. The OS 451 can be implemented in the context of system software that manages computer hardware and software resources and provides common services for computer programs.

One or more application programs, such as software application 454, may be “loaded” (i.e., transferred from, for example, mass storage or another memory location into the memory 342) for execution by the data-processing system/apparatus 400. The data-processing system/apparatus 400 can receive user commands and data through the interface 453; these inputs may then be acted upon by the data-processing system/apparatus 400 in accordance with instructions from operating system 451 and/or software application 454. The interface 453 in some embodiments can serve to display results, whereupon a user may supply additional inputs or terminate a session. The software application 454 can include module(s) 452, which can, for example, implement the various Instructions or operations such as those discussed herein. Module 452 may also be composed of a group of modules or sub-modules that implement particular modules, such as, for example, the various modules (and components/features, etc.) or components and operations discussed and illustrated herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. In other embodiments, a module may refer to a hardware component or a combination of hardware and software.

FIGS. 7-8 are thus intended as examples and not as architectural limitations of the disclosed embodiments. Additionally, such example embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, such as but not limited to Macintosh, Windows, Android, UNIX, LINUX, and so on.

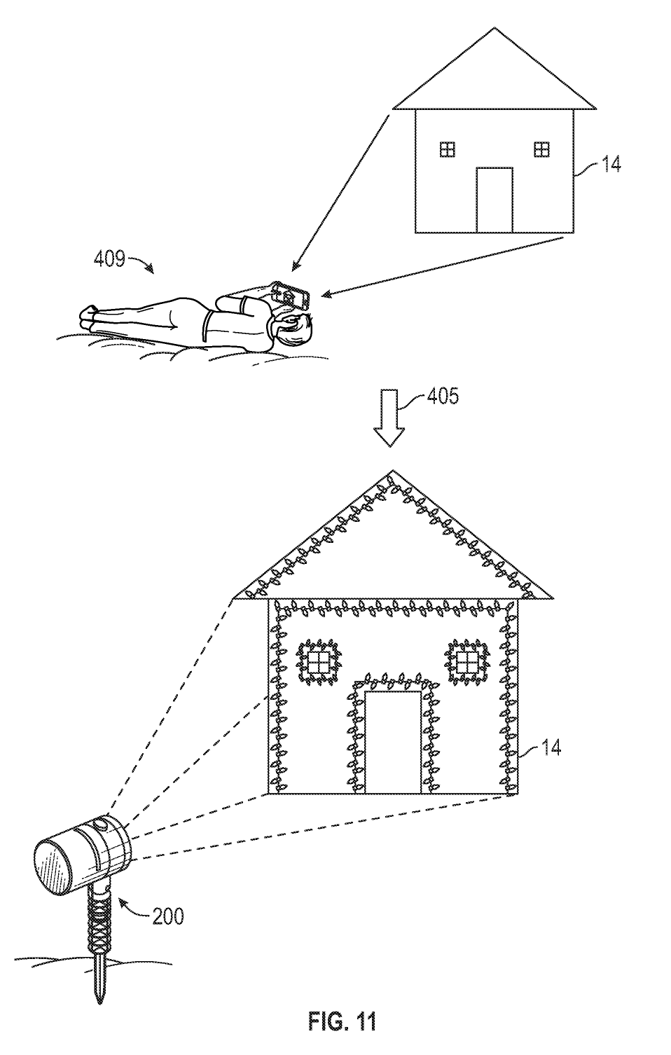

FIGS. 9-10 illustrate a pictorial flow diagram depicting operational steps of a process for implementing and operating a light customization software application (i.e., ‘app’) that dynamically projects and displays customized decorative images on a building or home, in accordance with an example embodiment. FIG. 9 shows a first step for using the aforementioned “app” and FIG. 10 illustrates a second and third step. Thus, step 1 shown in FIG. 9 demonstrates how a client device such as the client device 100 can be used to take a photo of a structure or house 115 as shown displayed within the display 112 of the client device 100. A user can press a graphically displayed button 101 which when pressed by the user takes a photo of the house vertically (see left side of FIG. 9) or horizontally (see right side of FIG. 9). Note that the client device 100 as shown in FIGS. 9-10 also can include an on/off button 103.

FIG. 10 illustrates various example “app” tools that can be used to design a light display to be projected for the particular structure or house 115 shown displayed in the display 112 in FIG. 9. The photo/image of the house 115 can be utilized to trace the desired or correct light paths. For example, a vertically displayed graphical toolbar 117 (e.g., a GUI toolbar) can be graphically displayed in the display 112, which can include features such as line trace features, and so on. The horizontally displayed toolbar 105 (e.g., a GUI toolbar) can provide the user with various projection style options.

The step 2 process flow shown in FIG. 10 is generally indicated by arrows 88, 89, and 91. For example, after the various app tools (e.g., provided by toolbars 105 and 117) are utilized with respect to the image/photo of the house 115 to design the projection light display, the resulting image/photo of the house 115 can then be shown with the light projection, after arrow 88. After arrow 99, a resulting image/photo 119 of the house 115 with the light projection is shown. That is, the app can be used to mix and combine light styles to create a custom projection design onto the originally captured image or photo of the structure of house 115.

After arrow 91, a block 121 labeled Step 3 is shown, which represents various options. The generic “Step 3” shown in FIG. 10 involves the final processing and creation of the image or projector slider. That is, once the user is pleased with the custom design, the design can be sent out electronically (as discussed previously) to be manufactured and mailed back in the form of a slide that allows for attenuation of the projector light to shine through and project the final customized light pattern. Note that in some example embodiments, the previously discussed projector 200 can be configured to communicate directly with the client device 100 and the “app” and use its basic projector technology to “instantly” project the customized light patterns and thereby avoid the manufacturing of a separate slide image. Note that an example of such a projector is a modified projector utilizing LCD (Liquid Crystal Display) technology.

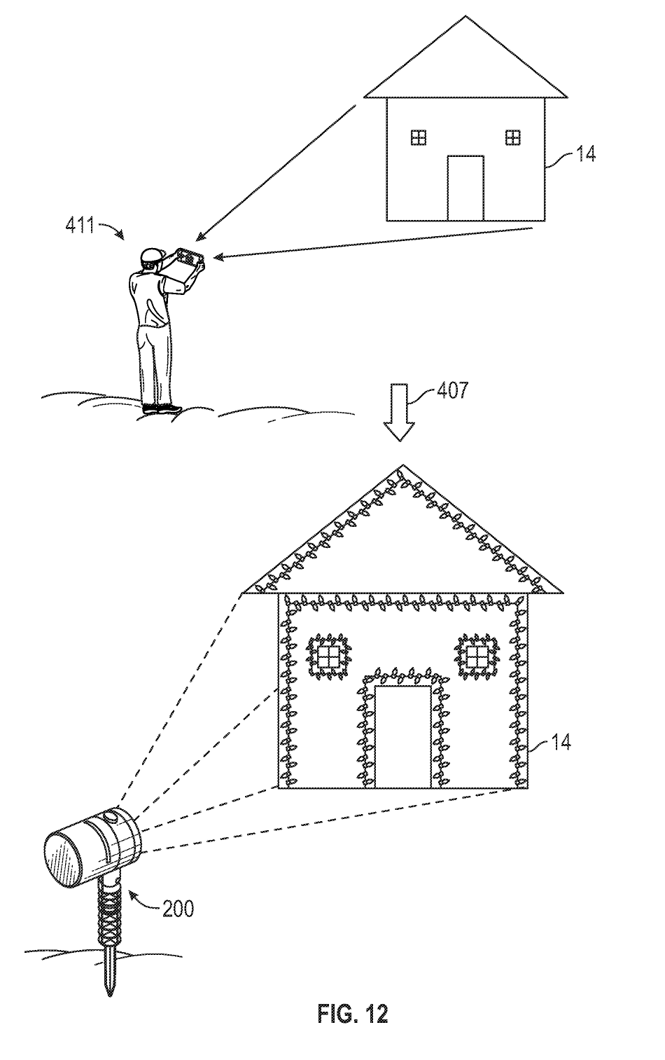

FIG. 11 illustrates a pictorial diagram depicting additional operations of app features for dynamically projecting and displaying customized decorative images on a building or home, in accordance with an example embodiment. FIG. 11 and FIG. 12 demonstrate two different methods for taking an image of a structure with the client device 100 and creating a light display for eventual projection back onto the structure. FIG. 11 indicates that the photo of house may be taken at ground level 409.

In addition, the projector mount (see projector 200 in FIG. 11) can be initially mounted in a manner that allows the image of the structure to be captured at the same viewing perspective as the projector 200, which will project the final light pattern back onto the structure. Arrow 405 shown in FIG. 11 indicates the initial capturing of the image of the house and after the image modified with the light design, and the eventual projection of the image (with the light display) back onto the house 14 from the ground level projector 200.

FIG. 12 illustrates an app feature that accounts for elevation difference of the client device 100 when the structure image is taken, which allows for the final light projection to be shifted to “ground level” where the projector will be placed (as indicated after arrow 407 in FIG. 12). This situation eases the user's experience and does not require the user to “lay” on the ground to take the initial image of the structure needed to overlay the light pattern using the previously discussed “app” features.

Based on the foregoing, it can be appreciated that a number of example embodiments are disclosed herein. For example, in a preferred example embodiment, a method can be implemented for displaying customized decorative lighting. Such a method can include steps or operation such as, for example, capturing an image of an area of a building with an image-capturing device; graphically modifying the image of the area of the building with customized decorative features, wherein the customized decorative features are added to the image of the area of the building via image processing; and generating a slide with the image of the area of the building including the customized decorative features added to the image as a result of the graphically modifying the image via the image processing, the slide receivable by a decorative lighting apparatus that includes a projector for projecting the modified image with the decorative images on the area of the building.

In some example embodiments, the aforementioned step of generating a slide with the image of the area of the building including the customized decorative features added to the image as a result of the graphically modifying the image via the image processing can involve the creation of a digital slide (with the image of the building and the light pattern) rather than a physical slide. This digital slide can be transmitted from a client device (e.g., such as client device 100) directly to a modified projector (e.g., projector 200), which is capable of communicating wirelessly with the client device (e.g., through, for example, Bluetooth wireless communications). In this particular example, the digital slide is transmitted to the modified projector directly and the projector then projects the image contained on the digital slide.

In any event, in some example embodiments, the image-capturing device can be a camera associated with a mobile device such as the client device 100. In some example embodiments, the aforementioned decorative lighting apparatus can be configured with a gap for receiving the slide for projection by the projector. In other example embodiments, the aforementioned step or operation of graphically modifying the image of the area of the building with customized decorative features, wherein the customized decorative features are added to the image of the area of the building via image processing, can further comprise a step or operation of graphically drawing the decorative features onto the image of the area of the building utilizing an app running on the mobile device, the app comprising a downloadable self-contained software application.

In yet another example embodiment, steps or operations can be provided for placing the decorative lighting apparatus (e.g., a projector such as projector 200) in the same location wherein the image of the area of the building was originally captured by the image-capturing device; and projecting with the projector of the decorative lighting apparatus, the modified image with the decorative features onto the area of the building at the same location.

In still another example embodiment, the customized decorative features can include at least one image of a customized light wherein the customized decorative features are projected by the projector of the decorative lighting apparatus onto the building from the slide.

In yet another example embodiment, a system for displaying customized decorative lighting can be implemented. Such a system can include, for example, a decorative lighting apparatus that includes a projector for projecting a modified image with customized decorative images onto an area of a building, wherein the image of the area of the building is captured by an the image-capturing device, and wherein the customized decorative features are added to the image of the area of the building via image processing; and a slide with the image of the area of the building configured with the customized decorative features added to the image as a result of the graphically modifying the image via the image processing, the slide receivable by the decorative lighting apparatus including the projector for projecting the modified image with the decorative images onto the area of the building. Note that the slide may be a digital slide as discussed previously, rather than a physical slide.

In still another example embodiment, a system for displaying customized decorative lighting can be implemented. Such a system can include, for example, at least one processor, and a non-transitory computer-usable medium embodying computer program code, the computer-usable medium capable of communicating with the at least one processor. The computer program code can include instructions executable by the at least one processor and configured for: capturing an image of an area of a building with an image-capturing device; graphically modifying the image of the area of the building with customized decorative features, wherein the customized decorative features are added to the image of the area of the building via image processing; and generating a slide with the image of the area of the building including the customized decorative features added to the image as a result of the graphically modifying the image via the image processing, the slide receivable by a decorative lighting apparatus that includes a projector for projecting the modified image with the decorative images on the area of the building.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for displaying customized decorative lighting, said method comprising:
capturing an image of an area of a building with an image-capturing device;
graphically modifying said image of said area of said building with customized decorative features, wherein said customized decorative features are added to said image of said area of said building via image processing; and
generating a slide with said image of said area of said building including said customized decorative features added to said image as a result of said graphically modifying said image via said image processing, said slide receivable by a decorative lighting apparatus that includes a projector for projecting said modified image with said decorative images on said area of said building.

2. The method of claim 1 wherein said image-capturing device comprises a camera associated with a mobile device.

3. The method of claim 1 wherein said decorative lighting apparatus is configured with a gap for receiving said slide for projection by said projector.

4. The method of claim 2 wherein said graphically modifying said image of said area of said building with customized decorative features, wherein said customized decorative features are added to said image of said area of said building via image processing, further comprises:
graphically drawing said decorative features onto said image of said area of said building utilizing an app running on said mobile device, said app comprising a downloadable self-contained software application.

5. The method of claim 1 further comprising:
placing said decorative lighting apparatus in a same location wherein said image of said area of said building was originally captured by said image-capturing device; and
projecting with said projector of said decorative lighting apparatus, said modified image with said decorative features onto said area of said building at said same location.

6. The method of claim 1 wherein said customized decorative features comprise at least one image of a customized light wherein said customized decorative features are projected by said projector of said decorative lighting apparatus onto said building from said slide.

7. A system for displaying customized decorative lighting, said system comprising:
a decorative lighting apparatus that includes a projector for projecting a modified image with customized decorative images onto an area of a building, wherein said image of said area of said building is captured by an said image-capturing device, and wherein said customized decorative features are added to said image of said area of said building via image processing; and
a slide with said image of said area of said building configured with said customized decorative features added to said image as a result of said graphically modifying said image via said image processing, said slide receivable by said decorative lighting apparatus including said projector for projecting said modified image with said decorative images onto said area of said building.

8. The system of claim 7 wherein said image-capturing device comprises a camera associated with a mobile device.

9. The system of claim 7 wherein said decorative lighting apparatus is configured with a gap for receiving said slide for projection by said projector.

10. The system of claim 8 wherein said graphically modifying said image comprises graphically drawing said decorative features onto said image of said area of said building utilizing an app running on said mobile device, said app comprising a downloadable self-contained software application.

11. The system of claim 8 wherein:
said decorative lighting apparatus is placed in a same location wherein said image of said area of said building was originally captured by said image-capturing device; and
said projector of said decorative lighting apparatus projects said modified image with said decorative features onto said area of said building at said same location.

12. The system of claim 7 wherein said customized decorative features comprise at least one image of a customized light wherein said customized decorative features are projected by said projector of said decorative lighting apparatus onto said building from said slide.

13. A system for displaying customized decorative lighting, said system comprising:
at least one processor, and
a non-transitory computer-usable medium embodying computer program code, said computer-usable medium capable of communicating with said at least one processor, said computer program code comprising instructions executable by said at least one processor and configured for:
capturing an image of an area of a building with an image-capturing device;
graphically modifying said image of said area of said building with customized decorative features, wherein said customized decorative features are added to said image of said area of said building via image processing; and
generating a slide with said image of said area of said building including said customized decorative features added to said image as a result of said graphically modifying said image via said image processing, said slide receivable by a decorative lighting apparatus that includes a projector for projecting said modified image with said decorative images on said area of said building.

14. The system of claim 13 wherein said image-capturing device comprises a camera associated with a mobile device.

15. The system of claim 3 wherein said decorative lighting apparatus is configured with a gap for receiving said slide for projection by said projector.

16. The system of claim 15 wherein said instructions for graphically modifying said image of said area of said building with customized decorative features, wherein said customized decorative features are added to said image of said area of said building via image processing, further comprise instructions configured for:
graphically drawing said decorative features onto said image of said area of said building utilizing an app running on said mobile device, said app comprising a downloadable self-contained software application.

17. The system of claim 12 wherein said instructions are further configured for:
placing said decorative lighting apparatus in a same location wherein said image of said area of said building was originally captured by said image-capturing device; and
projecting with said projector of said decorative lighting apparatus, said modified image with said decorative features onto said area of said building at said same location.

18. The system of claim 12 wherein said customized decorative features comprise at least one image of a customized light wherein said customized decorative features are projected by said projector of said decorative lighting apparatus onto said building from said slide.

19. The system of claim 12 further comprising instructions for displaying at least one toolbar comprising a plurality of projection style tools for use in configuring said customized decorative features.

20. The system of claim 12 further comprising instructions for displaying at least one toolbar comprising a plurality of line trace tools for use in configuring said customized decorative features.
